(19) United States
(12) Patent Application Publication
(10) Pub. No.: US 2026/0170239 A1
(43) Pub. Date: Jun. 18, 2026

(54) GAP AND COMPLIANCE ANALYSIS FOR TECHNICAL DOCUMENTS

(71) Applicant: Kyndryl, Inc., New York, NY (US)

(72) Inventors: Manish Gupta, New Delhi (IN); Sujith Rajeevakshan Pillai, Bengaluru (IN); Satyendra Kumar, Bengaluru (IN); Abhishek Kumar Chourasia, Bangalore (IN); Manish Khurana, Livermore, CA (US); Natarajan Rajavelu, San Ramon, CA (US); Sasi Kumar, Bengaluru (IN)

(21) Appl. No.: 18/981,733

(22) Filed: Dec. 16, 2024

(51) Int. Cl. G06F 40/186; G06F 40/103; G06Q 10/10

(52) U.S. Cl. CPC G06F 40/186; G06F 40/103; G06Q 10/10

(57) ABSTRACT

Computer-implemented methods are directed to gap and compliance analysis for technical documents. Aspects include determining an assessment type for a technical document received from a user device. Aspects also include analyzing the technical document using a set of microguidelines associated with the assessment type. Aspects further include generating an alignment score using the set of microguidelines. Aspects also include generating a recommendation for the technical document based on the alignment score and the set of microguidelines. Aspects further include initiating a modification to the technical document based on the recommendation for the technical document.

### BACKGROUND

The present invention generally relates to computer systems, and more specifically to computer-implemented methods, computer systems, and computer program products configured and arranged for gap and compliance analysis for technical documents.

Businesses and organizations often rely on technical documents to examine information and to track developments in their products, strategies, and other endeavors. These technical documents can be governed by guidelines and criteria that are developed by groups or individuals to ensure quality and completeness of information. The guidelines and criteria are stored in guideline documents, which can be managed by multiple individuals. To ensure that the technical documents are in compliance with the guidelines and criteria, an individual may need to be familiar with the guideline documents and capable of consistently applying the guidelines and criteria to the technical documents during their analysis.

### SUMMARY

Embodiments of the present invention are directed to computer-implemented methods for gap and compliance analysis for technical documents. A non-limiting computer-implemented method includes determining an assessment type for a technical document received from a user device. The method also includes analyzing the technical document using a set of microguidelines associated with the assessment type. The method further includes generating an alignment score using the set of microguidelines. The method also includes generating a recommendation for the technical document based on the alignment score and the set of microguidelines. The method further includes initiating a modification to the technical document based on the recommendation for the technical document.

In one embodiment of the present invention, the method includes receiving a guideline document from the user device. In some embodiments the guideline document is unstructured. The method also includes extracting a guideline from the guideline document. The method further includes determining the assessment type based on the guideline. The method also includes mapping the guideline to the existing microguideline in response to determining that the guideline corresponds to an existing microguideline of the set of microguidelines. In some embodiments, the method includes generating a new microguideline corresponding to the guideline in response to determining that the guideline does not correspond to the set of microguidelines associated with the assessment type. The method further includes associating the new microguideline with the assessment type.

In one embodiment of the present invention, the method includes receiving a weight modification for a microguideline of the set of microguidelines from the user device in response to the recommendation. The method also includes generating a user exception rule. The method further includes associating the user exception rule with a user profile associated with the user device and the assessment type. In some embodiments, the method includes re-analyzing the technical document using the set of microguidelines associated with the assessment type and the user exception rule associated with the user profile. The method further includes generating an adjusted alignment score using the set of microguidelines and the user exception rule. The method also includes generating an updated recommendation for the technical document based on the adjusted alignment score, the user exception rule, and the set of microguidelines.

In one embodiment of the present invention, the method includes determining a second assessment type for the technical document. The method also includes analyzing the technical document using a second set of microguidelines associated with the second assessment type. The method further includes generating a second alignment score using the second set of microguidelines. The method also includes generating an updated recommendation for the technical document using the second alignment score and the second set of microguidelines. The method further includes initiating a second modification to the technical document based on the updated recommendation for the technical document.

In one embodiment of the present invention, the recommendation includes the microguidelines, a weight for each of the set of microguidelines, data indicating that each of the set of microguidelines that was satisfied or not satisfied, identification of a gap or noncompliance in the technical document, and a remediation action for the gap or the noncompliance in the technical document.

According to another non-limiting embodiment of the invention, a system having a memory having computer-readable instructions and one or more processors for executing the computer readable instructions, the computer readable instructions controlling the one or more processors to perform operations. The operations include determining an assessment type for a technical document received from a user device. The operations also include analyzing the technical document using a set of microguidelines associated with the assessment type. The operations further include generating an alignment score using the set of microguidelines. The operations also include generating a recommendation for the technical document based on the alignment score and the set of microguidelines. The operations further include initiating a modification to the technical document based on the recommendation for the technical document.

According to another non-limiting embodiment of the invention, a computer program product is provided. The computer program product includes a computer-readable storage medium having program instructions embodied therewith, the program instructions executable by a processor to cause the processor to perform operations. The operations include determining an assessment type for a technical document received from a user device. The operations also include analyzing the technical document using a set of microguidelines associated with the assessment type. The operations further include generating an alignment score using the set of microguidelines. The operations also include generating a recommendation for the technical document based on the alignment score and the set of microguidelines. The operations further include initiating a modification to the technical document based on the recommendation for the technical document.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system for gap and compliance analysis for technical documents in a computing environment in accordance with one or more embodiments of the present invention;

FIG. 3 is a data flow diagram for gap and compliance analysis for technical documents in a computing environment in accordance with one or more embodiments of the present invention;

FIG. 4 is a data flow diagram for generating microguidelines from guidelines documents for gap and compliance analysis for technical documents in accordance with one or more embodiments of the present invention;

FIG. 5 is a data flow diagram for gap and compliance analysis for technical documents in a computing environment in accordance with one or more embodiments of the present invention;

FIG. 6 is a data flow diagram for analyzing technical documents and generating user exception rules for gap and compliance analysis for technical documents in a computing environment in accordance with one or more embodiments of the present invention;

FIG. 7 is a flowchart of a computer-implemented method for generating microguidelines for gap and compliance analysis for technical documents in a computing environment in accordance with one or more embodiments of the present invention;

FIG. 8 is a flowchart of a computer-implemented method for gap and compliance analysis for technical documents in accordance with one or more embodiments of the present invention;

FIG. 9 depicts a cloud computing environment in accordance with one or more embodiments of the present invention; and

FIG. 10 depicts abstraction model layers in accordance with one or more embodiments of the present invention.

### DETAILED DESCRIPTION

Disclosed herein are methods, systems, and computer program products for gap and compliance analysis of technical documents. As discussed above, technical documents need to comply with guidelines and criteria developed to ensure the completeness and quality of information within them. The guidelines and criteria are often stored in an unstructured guidelines document. The guideline documents can also contain examples and explanations for the guidelines. The technical documents that need to be analyzed using the guidelines are often unstructured, dense, and long. Manual review of the technical documents is often cumbersome and time-consuming and is vulnerable to bias and human error.

The systems and methods described herein are directed to providing gap and compliance analysis for technical documents using artificial intelligence, according to one or more embodiments. A user is able to provide a guideline document written in natural language and unstructured to the system. For example, the guideline document may be digitized in an electronic format. The system processes the guideline document to extract guidelines from the document and identify one or more assessment types associated within the guideline document. An assessment type is a collection of related microguidelines derived from guideline documents or other data. Microguidelines are simple atomic requirements of a guideline. Examples of different types of assessment types can include criteria and guidelines for specific users or customers, best practices guidelines for different types of technical documents, formatting guidelines, and the like. The system obtains microguidelines associated with the assessment type of the guideline document. The extracted guidelines from the guideline document are decomposed into simple guidelines that have a single criteria or requirement and mapped to existing microguidelines with the assistance of artificial intelligence.

In some embodiments, the system receives a technical document from a user device for gap and compliance analysis. The technical document is processed by the system. An assessment type to analyze the technical document can be provided by the user. In some embodiments, the assessment type can be determined by the system based on the content of the technical document. Microguidelines associated with the identified assessment type are obtained to analyze the technical document. The system can use artificial intelligence to analyze the technical document using the microguidelines to identify any compliance issues. The system can also generate an alignment score that reflects the alignment or compliance of the technical document with the microguidelines. In some embodiments, a recommendation is generated based on the analysis of the technical document and the alignment score.

The recommendation can also include one or more remediation actions. The remediation actions can include steps to bring the technical document into compliance with the guidelines, identification of missing information, and the like. In some embodiments, an automated resolution system can execute one or more remediation actions of the recommendation to modify the technical document and remedy one or more compliance issues identified during the analysis of the technical document. In one or more embodiments, a recommendation may determine that the technical document is to be brought into compliance with respect to the criteria embodied in the microguidelines. Accordingly, remediation actions are executed to modify the technical document.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

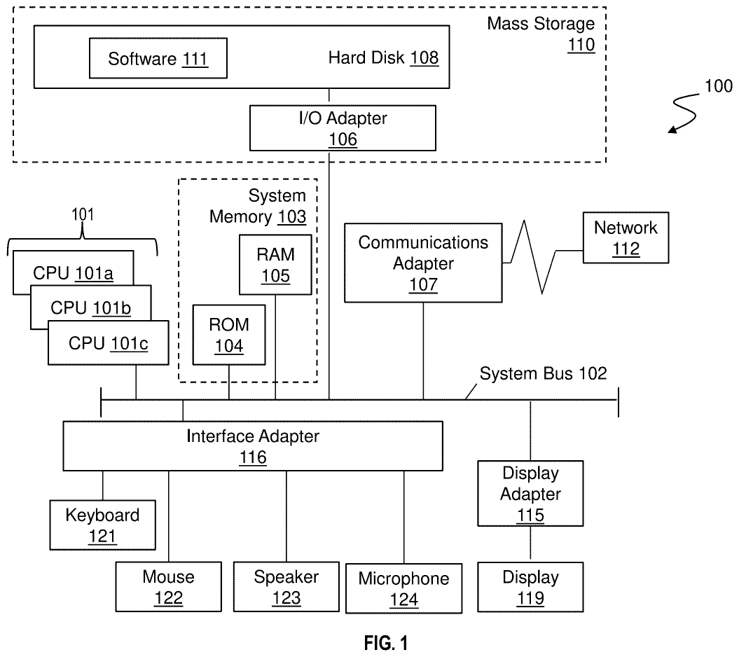

Turning now to FIG. 1, a computer system 100 is generally shown in accordance with one or more embodiments of the invention. The computer system 100 can be an electronic computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, a desktop computer, a laptop computer, a tablet computer, or a smartphone. In some examples, the computer system 100 may be a cloud computing node. The computer system 100 may be described in the general context of computer system executable instructions, such as program modules, being executed by a computer system. Generally, program modules may include routines, programs, objects, components, logic, data structures, and so on that perform tasks or implement abstract data types. The computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, a multi-core processor, a computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

The software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

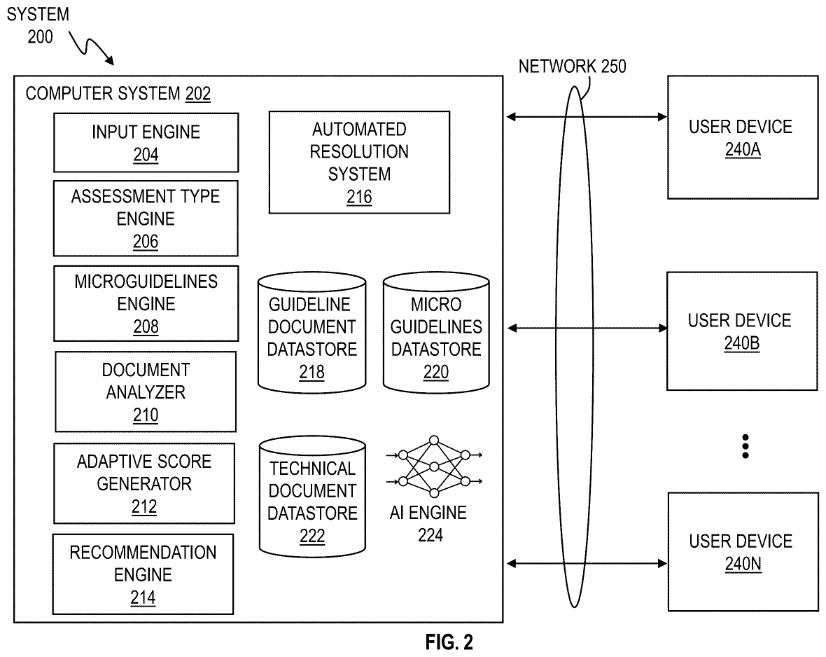

FIG. 2 depicts a block diagram of an example system 200 for a gap and compliance analysis for technical documents in a computing environment according to one or more embodiments. The system 200 includes a computer system 202 configured to communicate over a network 250 with many different user devices, such as a user device 240A, a user device 240B, through a user device 240N. The user devices 240A, 240B, through 240N can generally be referred to as user device 240 and are utilized to access the computing environment. The user device 240 can be a personal computer or laptop. The user device 240 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The user devices 240 can include various software and hardware components including software applications (apps) for communicating with one another over the network 250 as understood by one of ordinary skill in the art. The computer system 202, user device(s) 240, an input engine 204, an assessment type engine 206, a microguidelines engine 208, a document analyzer 210, an adaptive score generator 212, a recommendation engine 214, an automated resolution system 216, a guideline document datastore 218, a microguidelines datastore 220, a technical document datastore 222, an artificial intelligence (AI) engine 224, etc., can include functionality and features of the computer system 100 in FIG. 1, including various hardware components and various software applications, such as the software 111, which can be executed as instructions on one or more processors 101 in order to perform actions according to one or more embodiments of the invention. The input engine 204, assessment type engine 206, microguidelines engine 208, document analyzer 210, adaptive score generator 212, recommendation engine 214, automated resolution system 216, guideline document datastore 218, microguidelines datastore 220, technical document datastore 222, and/or AI engine 224 can include, be integrated with, and/or call other pieces of software, algorithms, application programming interfaces (APIs), etc., to operate as discussed herein.

In some embodiments, the computer system 202 can include one or more modules to analyze technical documents to identify gaps or noncompliance, generate alignment scores for the technical documents, and generate recommendations based on the alignment scores. For example, the computer system 202 can include an input engine 204, an assessment type engine 206, a microguidelines engine 208, a document analyzer 210, an adaptive score generator 212, a recommendation engine 214, an automated resolution system 216, a guideline document datastore 218, a microguidelines datastore 220, a technical document datastore 222, and/or an AI engine 224 to perform one or more operations for gap and compliance analysis for technical documents.

In some embodiments, the input engine 204 of the computer system 202 receives documents from one or more user devices 240. The documents received from the user device 240 can be guideline documents or technical documents. In some embodiments, a guideline document is an unstructured document that contains rules, criteria, and examples of best practices that need to be followed by another document, by one or more computer systems, etc. A guideline document can include customer requirements, technical functional requirements, syntax requirements, and the like. A technical document is an unstructured document that contains data that is subject to different rules and criteria that are needed to meet a set of guidelines. An example of a technical document is a low-level design document. In one or more embodiments, the technical document may be rules and criteria regarding one or more computer systems (e.g., host servers), software running on the computer systems, network bandwidth, memory (e.g., memory allocation), etc.

In some embodiments, the input engine 204 can receive and process a document, which may be a digital document in an electronic format. The input engine 204 processes the document received from the user device 240 by vectorizing and indexing the content of the document. The input engine 204 can use any known techniques for vectorization and indexing. The input engine 204 can vectorize the content of the document by transforming the content of the documents into numerical representations. In some embodiments, the input engine 204 stores the processed data of a guideline document in a guideline document datastore, such as guideline document datastore 218. In some embodiments, the input engine 204 stores the processed data of a technical document in a technical document datastore, such as technical document datastore 222.

In some embodiments, the assessment type engine 206 of the computer system 202 obtains the processed content of a guideline document or a technical document received from the user device 240 from the input engine 204. The assessment type engine 206 analyzes the processed content of the guideline document or the technical document to identify an assessment type. In some embodiments, an assessment type is a named collection of related microguidelines derived from guideline documents or other data. In some embodiments, the assessment type is associated with one or more keywords describing or related to the microguidelines or the criteria embodied in the microguidelines. Microguidelines are simple atomic requirements of a guideline. Examples of different types of assessment types can include criteria and guidelines for specific users or customers, best practices guidelines for different types of technical documents, formatting guidelines, criteria and guidelines for specific computer systems (e.g., host computer systems), and the like. In some embodiments, the assessment type engine 206 transmits the identified assessment types to the microguidelines engine 208 or the document analyzer 210.

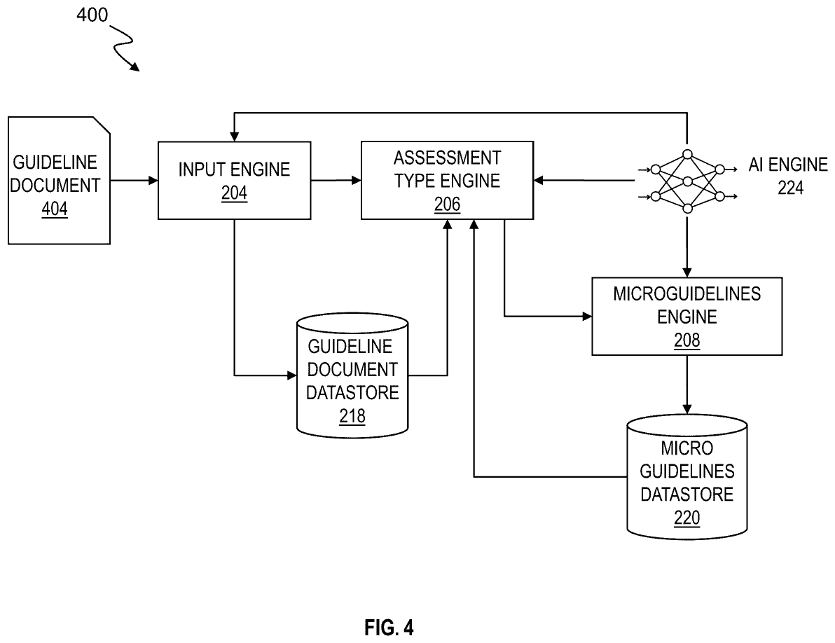

In some embodiments, the microguidelines engine 208 of the computer system 202 receives data from the assessment type engine 206 indicating one or more assessment types associated with the guideline document. The microguidelines engine 208 can obtain or retrieve microguidelines from a microguidelines datastore, such as microguidelines datastore 220. The microguidelines engine 208 facilitates mapping guidelines from the guideline document to microguidelines associated with the identified assessment type. In some embodiments, the microguidelines engine 208 instructs the AI engine 224 to extract guidelines from the processed content of the guideline document and deconstruct or decompose them into simple guidelines. In some embodiments, the AI engine 224 can be locally deployed on the user device 240. In some embodiments, the AI engine 224 is a service that is utilized by the user device 240. The AI engine 224 can then be instructed to map the simple guidelines to existing microguidelines associated with the identified assessment type or generate new microguidelines to map to the simple guidelines of the guidelines document, as further discussed in relation to FIG. 4.

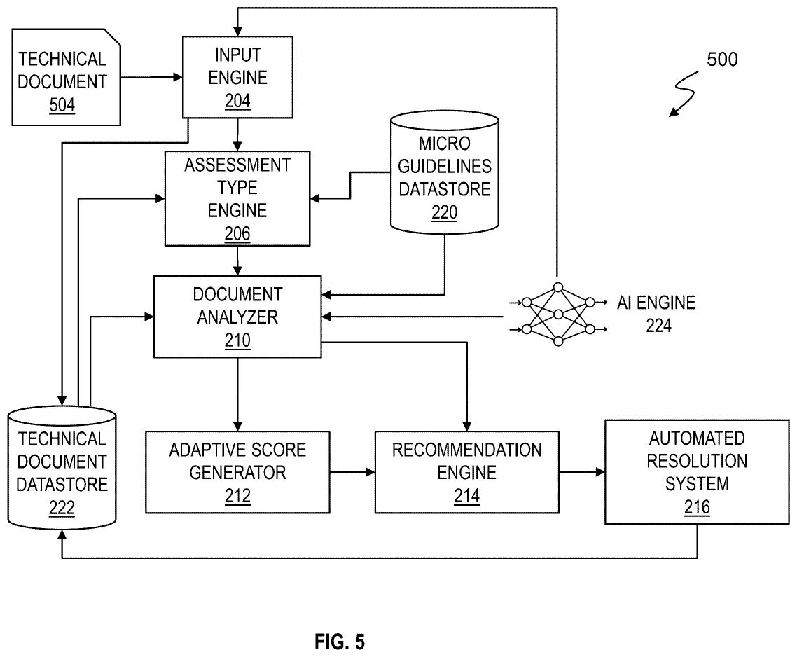

In some embodiments, the document analyzer 210 of the computer system 202 obtains or receives the processed content of a technical document. The processed content of the technical document can be received from the input engine 204 or from the technical document datastore 222. In some embodiments, the document analyzer 210 receives data from the assessment type engine 206 indicating one or more assessment types associated with the technical document. The document analyzer 210 obtains microguidelines associated with the assessment types associated with the technical document from the microguidelines datastore 220. The document analyzer 210 communicates with the AI engine 224 to analyze the technical document to identify any gaps or compliance issues using the microguidelines, as further discussed in FIG. 5.

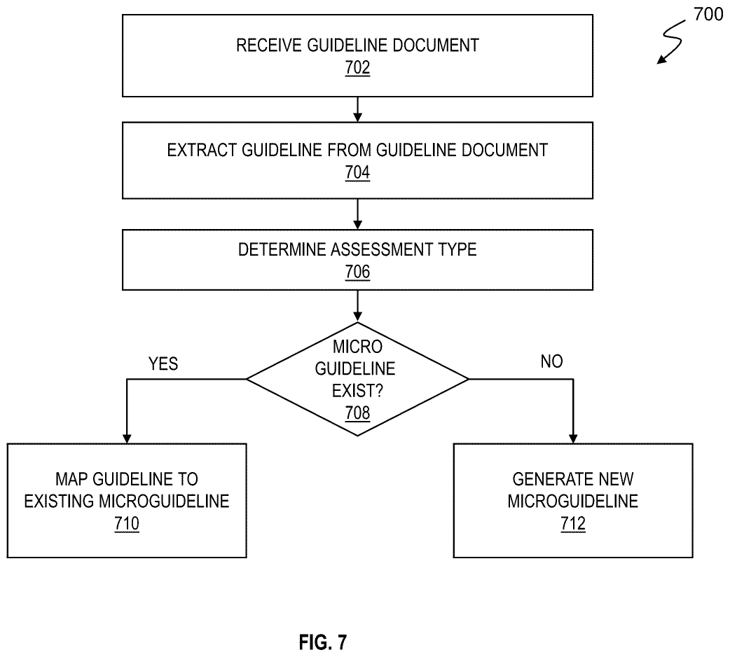

In some embodiments, the adaptive score generator 212 of the computer system 202 communicates with the document analyzer 210 and generates an alignment score for the technical document based on the analyzed content of the technical document. An alignment score is a numeric value indicative of how closely the technical document meets the microguidelines of the assessment type. In some embodiments, the adaptive score generator 212 calculates a value for each microguideline and then generates an overall alignment score for the technical document, as further discussed in relation to FIG. 7.

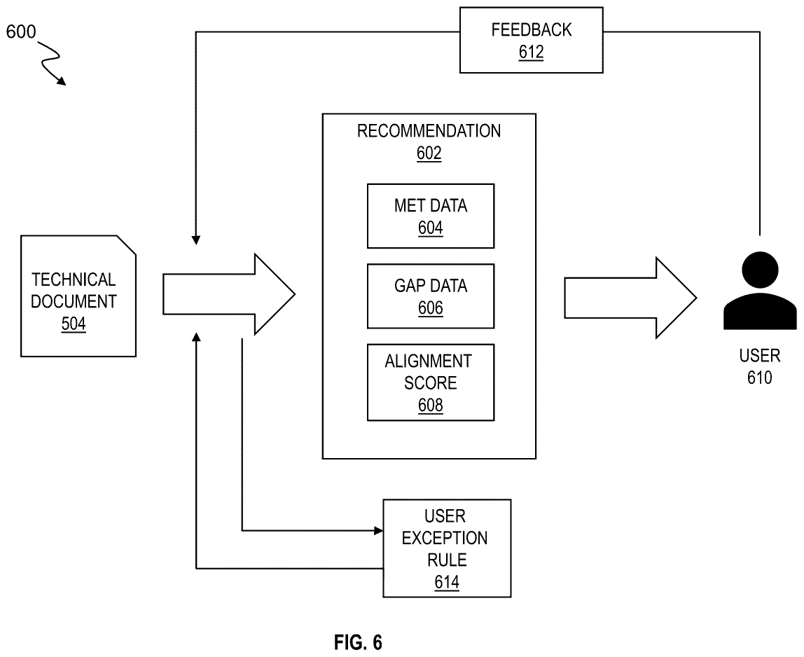

In some embodiments, the adaptive score generator 212 facilitates receiving feedback from a user of the user device 240 to modify a weight associated with a microguideline and generating an adjusted alignment score based on the feedback. The adaptive score generator 212 can also generate user exception rules based on the feedback received from the user and facilitate the use of the user exception rules in future calculations of the alignment score for that user, as further discussed in relation to FIG. 6.

In some embodiments, the recommendation engine 214 of the computer system 202 receives the analyzed data for the technical document from the document analyzer 210 and the alignment score from the adaptive score generator 212. The recommendation engine 214 generates a recommendation that can include data such as the microguidelines, a weight associated with each of the microguidelines, data indicating whether each of the microguidelines was satisfied or not satisfied, identification of a gap or noncompliance in the technical document, and/or a remediation action to cure the gap or the noncompliance in the technical document, which are further discussed in relation to FIG. 6.

In one or more embodiments, the computer system 202 includes and/or is coupled to an automated resolution system 216. Based on the recommendations generated by the recommendation engine 214, the automated resolution system 216 is configured to modify the technical document to cure identified compliance issues or the like. In some embodiments, if an alignment score meets a designated threshold value, the automated resolution system 216 performs one or more actions of a recommendation of the remediation action that makes modifications to the technical document. Although example values for the alignment score are illustrated, execution of the action in the recommendation is not limited to meeting the example threshold values for the alignment score. According to one or more embodiments, in response to the modification to the technical document to cure identified compliance issues or the like for one or more computer systems (e.g., host severs), the automated resolution system is configured to cause the technical document to comply with the criteria in the microguidelines, thereby improving the functioning of the computer systems described therein.

In some embodiments, based on the modified technical document, the automated resolution system 216 is configured to modify software components, hardware components, and/or both software and hardware components of one or more user devices 240 in the computing environment, thereby resulting in improvements to the computer systems themselves by complying with the criteria of the microguidelines of the modified technical document. The improvements can include updates to software, software patches, increased memory, released/decreased memory, increased/decreased CPU capability, increased/decreased I/O functionality, installing cybersecurity software, improved cybersecurity software, revoking permissions to sensitive data stored in a selected portion of memory, installing a firewall (with authentication software) between public data and sensitive data stored in the memory, etc. based on the modified technical document. The modifications to the software and/or hardware components solve technical computer problems on the computer systems in the computing environment and are practical applications associated with the modified technical document.

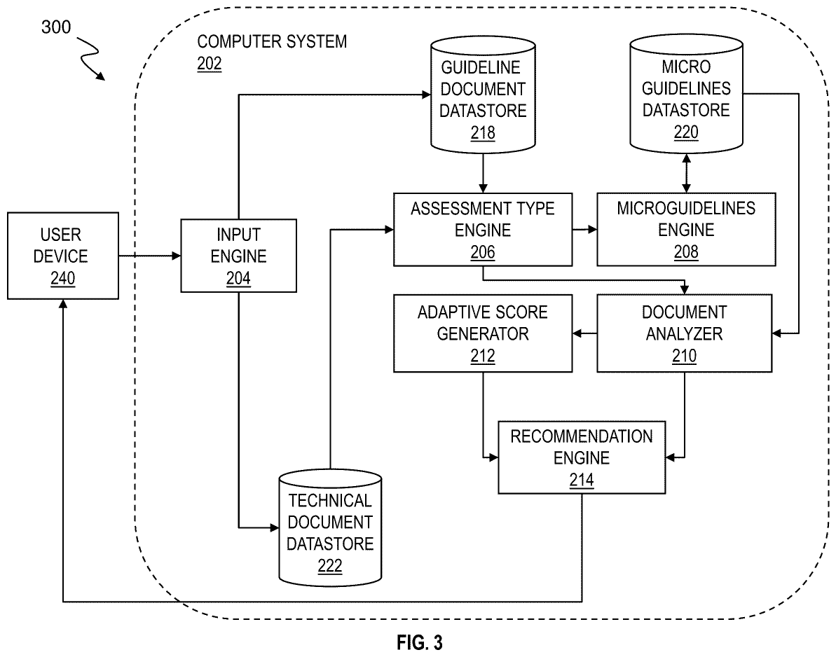

Now referring to FIG. 3, a data flow diagram 300 for gap and compliance analysis for technical documents in a computing environment is depicted. In some embodiments, a user operating a user device 240 can provide a document to the computer system 202 through a graphical user interface presented on the user device 240. An input engine 204 of the computer system 202 receives the document from the user device 240. In some embodiments, the document can be a guideline document or a technical document. The input engine 204 processes the document received from the user device 240 by vectorizing and indexing the content of the document. If the document is a guidelines document, the input engine 204 stores the processed content of the guidelines document in a guideline document datastore 218. If the document is a technical document, the input engine 204 stores the processed content of the technical document in the technical document datastore 222.

The assessment type engine 206 retrieves or obtains the processed content of the document received from the user device 240 from its respective datastore (e.g., guideline document datastore 218 or technical document datastore 222). The assessment type engine 206 analyzes the processed content of the document to identify an assessment type associated with the document received from the user device 240. In some embodiments, the assessment type engine 206 identifies one or more assessment types associated with the document received from the user device 240.

If the document received from the user device 240 is a guidelines document, the assessment type engine 206 transmits the identified assessment types to the microguidelines engine 208. The microguidelines engine 208 retrieves microguidelines associated with the identified assessment type from the microguidelines datastore 220. The microguidelines engine 208 analyzes the processed content of the guideline document and maps the content of the guideline document to existing microguidelines.

If the document received from the user device 240 is a technical document, the assessment type engine 206 transmits the identified assessment types to the document analyzer 210. The document analyzer 210 retrieves microguidelines associated with the identified assessment type from the microguidelines datastore 220. The document analyzer 210 uses the microguidelines associated with the identified assessment type and analyzes the content of the technical document. The document analyzer 210 can generate data that identifies any gaps or compliance issues in the content of the technical document. The document analyzer 210 communicates with the adaptive score generator 212 to generate an alignment score for the technical document based on the analysis of the content of the technical document by the document analyzer 210. The document analyzer 210 and the adaptive score generator 212 communicate with the recommendation engine 214.

In some embodiments, the recommendation engine 214 generates a recommendation based on the data received from the document analyzer 210 and the adaptive score generator 212. The recommendation can include a listing of the microguidelines that were used during the analysis of the technical document, data indicating whether each of the microguidelines was met or not, and identification of any gaps or compliance issues in the technical document. The recommendation can also include the alignment score of the technical document. In some embodiments, the recommendation includes a breakdown of how the alignment score was generated, which can include the weights associated with each of the microguidelines and the values determined by the adaptive score generator 212. In some embodiments, the recommendation can include one or more remediation actions to cure the identified gap or compliance issues of the technical document. The recommendation engine 214 transmits the recommendation to the user device 240 for presentation to the user of the user device 240.

Now referring to FIG. 4, a data flow diagram 400 for generating microguidelines from guidelines documents for gap and compliance analysis for technical documents in accordance with one or more embodiments of the present invention is depicted. As discussed above, a user device 240 can upload or provide a guideline document 404 to the computer system 202. The guideline document 404 is a document or file that contains criteria, guidelines, best practices, functional requirements, non-functional requirements, and the like that must be followed by technical documents. Guideline documents 404 can be created by a governance committee of an organization or group or an individual. Guideline documents 404 can include multiple guidelines, which can be simple or composite guidelines (e.g., multiple requirements in a guideline). A guideline document 404 can also include objectives for the guidelines, explanations, examples, and suggestions. In some embodiments, the guideline document 404 is provided from the user device 240 using a graphical user interface, such as through a webpage or mobile application. The guideline document 404 is transmitted from the user device 240 to the computer system 202.

The input engine 204 of the computer system 202 receives the guideline document 404 from the user device 240. The input engine 204 processes the guideline document 404. In some embodiments, the input engine 204 can communicate with the AI engine 224 to process the guideline document 404. For example, the AI engine 224 uses retrieval-augmented generation (RAG) to process the guideline document 404. RAG is an AI framework that combines data retrieval and a text generator model where a large language model (LLM) is modified to respond to user queries with reference to a specified set of data stored in a vector database, such as the guideline document datastore 218, in addition to the data drawn from its training. The data stored in the guideline document datastore 218 can be from previously processed guideline documents that were vectorized or converted into embeddings, which are numerical representations of data in the form of large vectors that allow for document retrieval.

The AI engine 224 can vectorize and index the guideline document 404 using any known techniques to vectorize and index the guideline document 404 to generate processed content from the guideline document 404. In some embodiments, the AI engine 224 can segment or chunkify the guideline document 404 before vectorizing and indexing the guideline document 404 for easier and more efficient data retrieval. The input engine 204 can facilitate transforming the content of the guideline document 404 into embeddings that are numerical representations stored as vectors that can be used by machine learning algorithms, such as those used by AI engine 224, to analyze the content of the guideline document 404, such as through topic categorization, sentiment analysis, language identification, and the like. The input engine 204 can transmit the processed content of the guideline document 404 to the guideline document datastore 218 for storage.

The assessment type engine 206 receives a notification from the input engine 204 that the guideline document 404 has been processed and transmitted to the guideline document datastore 218 for storage. The assessment type engine 206 obtains the processed content of the guideline document 404 from the guideline document datastore 218. In some embodiments, the assessment type engine 206 uses a multi-query retriever to obtain the processed content of the guideline document 404 from the guideline document datastore 218. The assessment type engine 206 instructs the AI engine 224 to extract guidelines from the processed content of the guideline document 404 and analyze the extracted guidelines to identify one or more assessment types. As discussed above, an assessment type is a collection of related microguidelines derived from guideline documents 404 or other data. Assessment types can include criteria and guidelines for specific users or customers, best practices guidelines for different types of technical documents, formatting guidelines, and the like. Microguidelines can be associated with multiple assessment types. The assessment type engine 206 determines one or more assessment types associated with the guideline document 404 by analyzing the extracted guidelines using known techniques of topic categorization, sentiment analysis, language identification, and the like and comparing the results with assessment type data obtained from the microguidelines datastore 220. The assessment type engine 206 identifies one or more assessment types for the guideline document 404 and transmits the assessment type and the extracted guidelines from the guideline document 404 to the microguidelines engine 208.

The microguidelines engine 208 receives the data from the assessment type engine 206 and retrieves microguidelines associated with the identified assessment type from the microguidelines datastore 220. In some embodiments, the microguidelines engine 208 instructs the AI engine 224 to decompose or deconstruct the guidelines from the assessment type engine 206 into simple guidelines that have a single requirement, condition, or constraint and then map the simple guidelines to existing microguidelines associated with the identified assessment type.

If the AI engine 224 determines that there is not an existing microguideline corresponding to the simple guideline, then the microguidelines engine 208 instructs the AI engine 224 to generate a new microguideline that corresponds to the simple guideline and associate it with the assessment type. In some embodiments, the microguidelines engine 208 facilitates presentation of the newly generated microguideline to the user of the user device 240 and requests confirmation that the user accepts the newly generated microguideline. In response to receiving confirmation from the user, the microguidelines engine 208 associates the newly generated microguideline with the assessment type and transmits it to the microguidelines datastore 220 for storage. In some embodiments, the microguidelines engine 208 instructs the AI engine 224 to generate multiple new microguidelines that correspond to the simple guideline. As noted above, the microguidelines engine 208 facilitates presentation of the multiple newly generated microguideline to the user of the user device 240 and requests that the user select one of the multiple newly generated microguidelines to associated with the guideline from the guideline document 404. In response to receiving a selection of one of the newly generated guidelines from the user, the microguidelines engine 208 associates the newly generated microguideline selected by the user with the assessment type and transmits it to the microguidelines datastore 220 for storage. In some embodiments, the microguidelines engine 208 generates and transmits a notification to the user device 240 indicating that the guideline document 404 has been successfully uploaded and mapped.

Now referring to FIG. 5, a data flow diagram 500 for gap and compliance analysis for technical documents 504 in a computing environment in accordance with one or more embodiments of the present invention is depicted. Similar to the data flow in FIG. 4, a user device 240 can upload or provide a technical document 504 to the computer system 202. A technical document 504 is a document that needs to be in compliance with a set of guidelines, such as those listed in guideline documents 404. In some embodiments, the technical document 504 is provided from the user device 240 using a graphical user interface, such as through a webpage or mobile application. The technical document 504 is transmitted from the user device 240 to the computer system 202. In one or more embodiments, the technical document may be for ensuring the compliance of software and/or hardware in one or more computer systems (e.g., host servers).

The input engine 204 of the computer system 202 receives the technical document 504 from the user device 240. The input engine 204 processes the technical document 504. In some embodiments, the input engine 204 communicates with the AI engine 224 to process the technical document 504. The AI engine 224 can vectorize and index the technical document 504 using any known techniques to vectorize and index the technical document 504 to generate processed content from the technical document 504. In some embodiments, the AI engine 224 extracts images and context information associated with the image (e.g., captions, references in text, etc.) from the technical document 504, generates text summary of the image and context, and vectorizes and indexes the text summary. In some embodiments, the AI engine 224 can segment or chunkify the technical document 504 before vectorizing and indexing the technical document 504. The input engine 204 can facilitate transforming the content of the technical document 504 into embeddings and transmit them to the technical document datastore 222 for storage.

The assessment type engine 206 receives a notification from the input engine 204 that the technical document 504 has been processed and transmitted to the technical document datastore 222 for storage. The assessment type engine 206 obtains the processed content of the technical document 504 from the technical document datastore 222. In some embodiments, the assessment type engine 206 uses a multi-query retriever to obtain the processed content of the technical document 504 from the technical document datastore 222. The assessment type engine 206 instructs the AI engine 224 to extract keywords and phrases from the processed content of the technical document 504 and analyze the extracted keywords and phrases to identify one or more assessment types. The assessment type engine 206 determines one or more assessment types associated with the technical document 504 by analyzing the extracted keywords and phrases using known techniques of topic categorization, sentiment analysis, language identification, and the like and comparing the results with assessment type data obtained from the microguidelines datastore 220. The assessment type engine 206 identifies one or more assessment types for the technical document 504 and transmits the one or more identified assessment type to the document analyzer 210.

The document analyzer 210 receives the assessment type from the assessment type engine 206 and obtains the processed content of the technical document from the technical document datastore 222. The technical document 504 obtains microguidelines associated with the identified assessment type from the microguidelines datastore 220. The document analyzer 210 instructs the AI engine 224 to use the microguidelines to analyze the technical document 504. The AI engine 224 identifies any gaps or compliance issues in the technical document 504 using the microguidelines. The AI engine 224 determines if each of the microguidelines has been met or satisfied. If the microguideline has not been satisfied, the AI engine 224 determines what element of the microguideline has not been satisfied and generates remediation actions that are needed to satisfy the microguideline. In some embodiments, the remediation action can include identification of missing data or actions to take in order to satisfy the microguidelines, such as suggested edits in formatting, content, word usage, and the like. In some embodiments, the AI engine 224 identifies gaps in the technical document 504 based on analysis. The AI engine 224 identifies the location of the gap in the technical document 504 and data that indicates what information needs to be provided to cure the gap. The AI engine 224 can generate remediation actions based on the gap and the information/data that is needed to cure the gap.

In some embodiments, the document analyzer 210 transmits data generated during the analysis of the technical document 504 to the adaptive score generator 212. The adaptive score generator 212 generates a score for each of the microguidelines that indicates how much of the microguideline has been met. The adaptive score generator 212 applies a weight associated with the microguideline to the score to generate a microguideline score. In some embodiments, the adaptive score generator 212 applies any user exception rules previously generated for the user associated with the user device 240 to generate the microguideline score. User exception rules are rules that replace the specified weight associated with the microguideline with a modified weight previously provided by a user of the user device 240, as further discussed in FIG. 6.

The adaptive score generator 212 generates the alignment score by using the microguideline score for each of the microguidelines associated with the assessment type. In some embodiments, the adaptive score generator 212 takes the average of all the microguideline scores associated with the assessment type of the technical document 504.

Next, the recommendation engine 214 receives information from the document analyzer 210 and the adaptive score generator 212. The recommendation engine 214 generates a recommendation 602 that includes data about the technical document 504, such as title, length, number of characters, size of the technical document 504, and the like. The recommendation can include data generated from the analysis by the document analyzer 210, which can include a listing of the microguidelines in natural language, data indicating whether the microguidelines have been met or satisfied, data identifying any gaps in the technical document 504, and remediation actions. The recommendation can also include the alignment score generated by the adaptive score generator 212. The recommendation engine 214 transmits the recommendation 602 to the user device 240 for presentation to the user.

In some embodiments, the automated resolution system 216 receives an indication from the user device 240 specifying one or more remediation actions to execute. The automated resolution system 216 modifies the technical document 504 based on the selected remediation actions. In some embodiments, the automated resolution system 216 compares the alignment score of the recommendation to a threshold specified by an administrator of the computer system 202. If the alignment score meets or exceeds the threshold, the automated resolution system 216 executes one or more remediation steps to modify the technical document 504. In one or more embodiments, the automated resolution system 216 may receive the recommendation and/or the information/data that is needed to cure the gap in the technical document, which bring the content embodied in the technical document 504 into compliance for one or more computer systems.

Now referring to FIG. 6, a data flow diagram 600 for generating user exception rules for gap and compliance analysis for technical documents 504 in a computing environment in accordance with one or more embodiments of the present invention is depicted.

As discussed above, a technical document 504 is analyzed using microguidelines and the recommendation engine 214 can generate a recommendation 602. The recommendation 602 can include met data 604, gap data 606, and the alignment score 608. In some embodiments, the met data 604 is generated by the recommendation engine 214 and the AI engine 224. Met data 604 is data that indicates if each of the microguidelines has been met or satisfied. If the microguideline has not been satisfied, the met data 604 includes data that indicates what element of the microguideline has not been satisfied and generates remediation actions that are needed to satisfy the microguideline. In some embodiments, the remediation action can include identification of missing data or actions to take in order to satisfy the microguidelines, such as suggested edits in formatting, content, word usage, and the like.

In some embodiments, the recommendation 602 includes gap data 606 generated by the recommendation engine 214 and the AI engine 224. The gap data 606 is data that identifies gaps in the technical document 504 based on the analysis by the document analyzer 210. The gap data 606 identifies the location of the gap in the technical document 504 and data that indicates what information needs to be provided to cure the gap. Remediation actions are generated based on the gap data 606.

In some embodiments, the recommendation engine 214 transmits the recommendation 602 to the user device 240 for presentation to a user 610. The user can provide feedback 612 to the recommendation engine 214 indicating a weight modification request to adjust the weight value associated with a microguideline. The recommendation engine 214 transmits the feedback 612 to the adaptive score generator 212. The adaptive score generator 212 generates a user exception rule 614 based on the feedback 612 and associates the user exception rule 614 with a user profile associated with the user 610 and the assessment type of the microguideline.

In response to generating the user exception rule 614, the adaptive score generator 212 generates an adjusted alignment score using the microguidelines and the user exception rule 614. The recommendation engine 214 generates an updated recommendation 602 for the technical document 504 based on the adjusted alignment score, the user exception rule 614, and the microguidelines and transmits the updated recommendation to the user device 240 for presentation to the user 610. In some embodiments, the adaptive score generator 212 uses the user exception rule 614 associated with the user profile of a user 610 requesting analysis of new technical documents 504 to generate the alignment scores 608.

Now referring to FIG. 7, a flowchart depicts a computer-implemented method 700 for generating microguidelines for gap and compliance analysis for technical documents in a computing environment in accordance with one or more embodiments of the present invention is depicted. The computer-implemented method 700 is executed by the computer system 202. Reference can be made to any figures discussed herein.

At block 702 for the computer-implemented method 700, a guideline document 404 is received. In some embodiments, a user 610 interacts with a user device 240 to provide a guideline document 404 to the input engine 204. The input engine 204 instructs the AI engine 224 to process the guideline document 404. In some embodiments, the AI engine 224 processes the guideline document 404 by vectorizing and indexing the content of the guideline document 404. In some embodiments, the input engine 204 transmits the processed content of the guideline document 404 to the assessment type engine 206. In some embodiments, the input engine 204 transmits the processed content of the guideline document 404 to the guideline document datastore 218 for storage.

Next at block 704, guidelines are extracted from the guideline document 404. In some embodiments, the assessment type engine 206 receives or obtains the processed content of the guideline document 404. The assessment type engine 206 communicates with the AI engine 224 to facilitate extraction of one or more guidelines from the processed content of the guideline document 404. The AI engine 224 can use any known techniques to identify and extract guidelines from the guideline document 404.

Continuing at block 706, the assessment type engine 206 analyzes the extracted guidelines to identify one or more assessment types. The assessment type engine 206 identifies one or more assessment types associated with the guideline document 404 by analyzing the extracted guidelines using known techniques of topic categorization, sentiment analysis, language identification, and the like and comparing the results with assessment type data obtained from the microguidelines datastore 220. In some embodiments, the assessment type data can be data associated with a microguideline that indicate that the microguideline is associated with an assessment type. Examples of assessment type data can include metadata of the microguideline, tags, labels, and the like. The assessment type engine 206 identifies one or more assessment types for the guideline document 404 and transmits the assessment type and the extracted guidelines from the guideline document 404 to the microguidelines engine 208.

Next at block 708, the microguidelines engine 208 determines if microguidelines corresponding to the extracted guidelines exist. In some embodiments, the extracted guidelines are composite guidelines that include more than a single requirement or condition. The microguidelines engine 208 decomposes or deconstructs the extracted guidelines into simple guidelines that include a single requirement or condition. The microguidelines engine 208 can communicate with the AI engine 224 to determine whether a microguideline corresponding to the simple guideline exists. The AI engine 224 can use any known methods or techniques for comparing the simple guidelines derived from the guideline document 404 and the microguidelines associated with the identified assessment type of the guideline document 404. If the AI engine 224 determines that a microguideline corresponding to the simple guideline exists, the method 700 proceeds to block 710. If the AI engine 224 determines that a microguideline corresponding to the simple guideline does not exist, the method 700 proceeds to block 712.

At block 710, the simple guideline is mapped to the existing microguideline. In some embodiments, the microguidelines engine 208 associates the simple guideline to the existing microguideline by updating metadata associated with the microguideline to indicate that the microguideline is associated with the guideline document 404.

At block 712, in response to determining that a microguideline corresponding to the simple guideline derived from the guideline document 404 does not exist, a new microguideline is generated. In some embodiments, the microguidelines engine 208 instructs the AI engine 224 to generate a new microguideline that corresponds to the simple guideline. The microguidelines engine 208 facilitates presentation of the newly generated microguideline to the user 610 of the user device 240. In response to receiving confirmation from the user 610 to accept the newly generated microguideline, the microguidelines engine 208 associates the newly generated microguideline with the identified assessment type. In some embodiments, the microguidelines engine 208 instructs the AI engine 224 to generate multiple new microguidelines that corresponds to the simple guideline and facilitates presentation of the newly generated microguidelines to the user 610 of the user device 240. In response to receiving a selection of one of the newly generated guidelines from the user 610, the microguidelines engine 208 associates the selected microguideline with the identified assessment type.

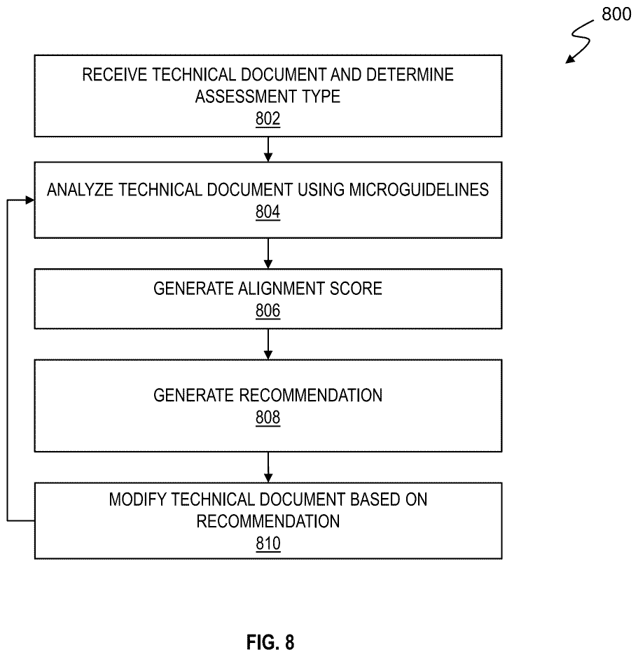

Now referring to FIG. 8, a flowchart depicts a computer-implemented method 800 for gap and compliance analysis for technical documents in a computing environment. The computer-implemented method 800 is executed by the computer system 202. Reference can be made to any figures discussed herein.

At block 802 for the computer-implemented method 800, a technical document 504 is received and an assessment type associated with the technical document 504 is determined. In some embodiments, the input engine 204 receives and processes the technical document 504. In some embodiments, the input engine 204 instructs the AI engine 224 to process the technical document 504 by vectorizing and indexing the technical document 504 to generate processed content. The input engine 204 transmits the processed content from the technical document 504 to the technical document datastore 222.

In some embodiments, the user 610 specifies one or more assessment types to use to analyze the technical document 504. The assessment types specified by the user are transmitted to the document analyzer 210. In some embodiments, if the user 610 does not specify an assessment type to use to analyze the technical document 504, the assessment type engine 206 retrieves the processed content of the technical document 504 from the technical document datastore 222 and instructs the AI engine 224 to extract keywords and phrases from the processed content of the technical document 504. The AI engine 224 analyzes the extracted keywords and phrases to identify one or more assessment types. The assessment type engine 206 determines one or more assessment types associated with the technical document 504 by analyzing the extracted keywords and phrases using known techniques of topic categorization, sentiment analysis, language identification, and the like and comparing the results with assessment type data obtained from the microguidelines datastore 220. The assessment type engine 206 transmits the identified assessment type to the document analyzer 210.

At block 804, the technical document 504 is analyzed using the microguidelines. The document analyzer 210 receives the identified assessment type to use to analyze the technical document 504. The document analyzer 210 retrieves the microguidelines associated with the assessment type from the microguidelines datastore 220. The document analyzer 210 communicates with the AI engine 224 to use the microguidelines to identify any gaps or compliance issues in the technical document 504. The AI engine 224 generates met data 604 that indicates if each of the microguidelines has been met or satisfied. If the microguideline has not been satisfied, the AI engine 224 generates met data 604 that indicates what element of the microguideline has not been satisfied and generates remediation actions that are needed to satisfy the microguideline. In some embodiments, the remediation action can include identification of missing data or actions to take in order to satisfy the microguidelines, such as suggested edits in formatting, content, word usage, and the like. In some embodiments, the AI engine 224 generates gap data 606 that identifies gaps in the technical document 504 based on analysis. The AI engine 224 generates gap data 606 that identifies the location of the gap in the technical document 504 and data that indicates what information needs to be provided to cure the gap. The AI engine 224 can generate remediation actions based on the gap and the information that is needed to cure the gap.

At block 806, an alignment score 608 is generated. The document analyzer 210 communicates with the adaptive score generator and transmits data generated during the analysis of the technical document 504. The adaptive score generator 212 uses the data received from the document analyzer 210 to generate a score for each of the microguidelines indicating how much of the microguideline has been met. The adaptive score generator 212 then generates a microguideline score by applying a weight associated with the microguideline to the score for the microguideline. The adaptive score generator 212 then generates the alignment score 608 by microguideline score for each of the microguidelines associated with the assessment type. In some embodiments, the adaptive score generator 212 takes the average of all the microguideline scores associated with the assessment type of the technical document 504.

At block 808 a recommendation 602 is generated. The recommendation engine 214 receives information from the document analyzer 210 and the adaptive score generator 212. The recommendation engine 214 generates a recommendation 602 that includes data about the technical document 504, such as title, length, number of characters, size of the technical document 504, and the like. The recommendation 602 can include data generated from the analysis by the document analyzer 210, which can include a listing of the microguidelines in natural language, met data 604, gap data 606, and remediation actions. The recommendation 602 can also include the alignment score 608 generated by the adaptive score generator 212. The recommendation engine 214 transmits the recommendation 602 to the user device 240 for presentation to the user 610.

At block 810, the technical document 504 is automatically modified based on the recommendation 602. In some embodiments, the automated resolution system 216 receives an indication from the user device 240 specifying one or more remediation actions to execute. The automated resolution system 216 automatically modifies the technical document 504 based on the selected remediation actions. In some embodiments, the method 800 can proceed back to block 804 to analyze the updated technical document 504.

In some embodiments, the automated resolution system 216 compares the alignment score 608 of the recommendation 602 to a threshold specified by an administrator of the computer system 202. If the alignment score 608 meets or exceeds the threshold, the automated resolution system 216 can execute one or more remediation steps to modify the technical document 504. The method 800 can proceed to block 804 to analyze the updated technical document 504. In some embodiments, the automated resolution system 216 can execute one or more remediation steps to modify the technical document 504 until a minimum alignment score threshold is met.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

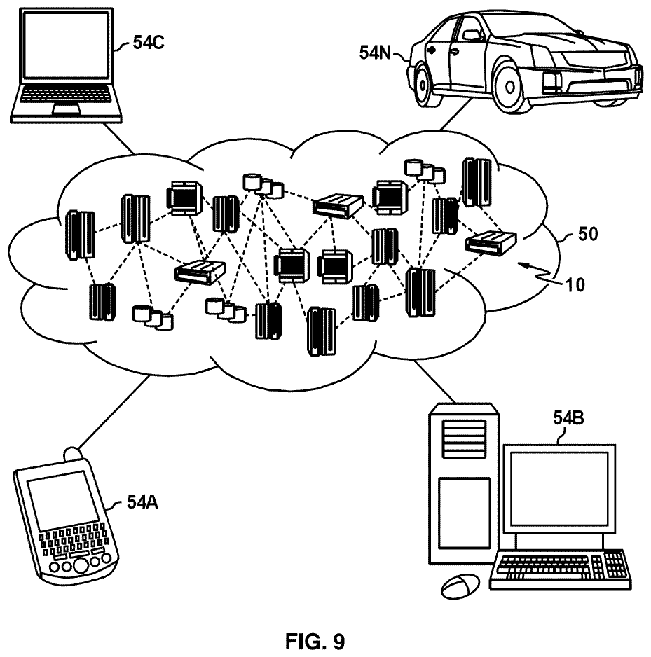

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

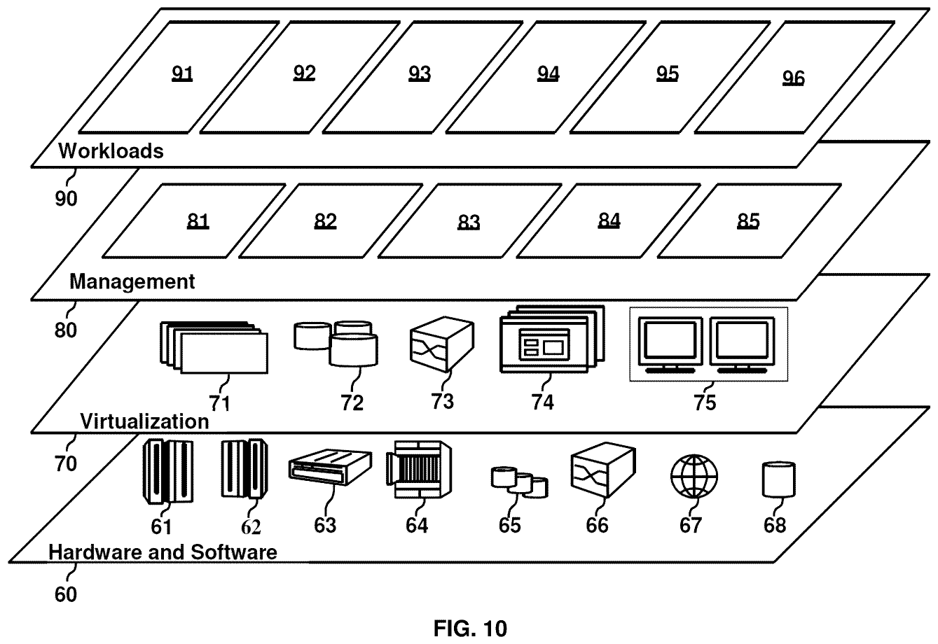

Referring now to FIG. 10, a set of functional abstraction layers provided by cloud computing environment 50 (depicted in FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. Examples of workloads and functions 96 include receiving guideline documents to generate microguidelines associated with an assessment type and analyzing technical documents using microguidelines associated with an assessment type. The workloads and functions 96 generating a recommendation that includes an alignment score for the technical document based on the microguidelines. The recommendation includes identification of any gaps or noncompliance of the technical document. The workloads and functions 96 include a system that modifies the technical document based on a generated recommendation by the systems and methods described herein.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
determining an assessment type for a technical document received from a user device;
analyzing the technical document using a set of microguidelines associated with the assessment type;
generating an alignment score using the set of microguidelines;
generating a recommendation for the technical document based on the alignment score and the set of microguidelines; and
initiating a modification to the technical document based on the recommendation for the technical document.

2. The computer-implemented method of claim 1, further comprising:
receiving a guideline document from the user device, wherein the guideline document is unstructured;
extracting a guideline from the guideline document;
determining the assessment type based on the guideline; and
in response to determining that the guideline corresponds to an existing microguideline of the set of microguidelines, mapping the guideline to the existing microguideline.

3. The computer-implemented method of claim 2, further comprising:
in response to determining that the guideline does not correspond to the set of microguidelines associated with the assessment type, generating a new microguideline corresponding to the guideline; and
associating the new microguideline with the assessment type.

4. The computer-implemented method of claim 1, further comprising:
in response to the recommendation, receiving a weight modification for a microguideline of the set of microguidelines from the user device;
generating a user exception rule; and
associating the user exception rule with a user profile associated with the user device and the assessment type.

5. The computer-implemented method of claim 4, further comprising:
re-analyzing the technical document using the set of microguidelines associated with the assessment type and the user exception rule associated with the user profile;
generating an adjusted alignment score using the set of microguidelines and the user exception rule; and
generating an updated recommendation for the technical document based on the adjusted alignment score, the user exception rule, and the set of microguidelines.

6. The computer-implemented method of claim 1, further comprising:
determining a second assessment type for the technical document;
analyzing the technical document using a second set of microguidelines associated with the second assessment type;
generating a second alignment score using the second set of microguidelines;
generating an updated recommendation for the technical document using the second alignment score and the second set of microguidelines; and
initiating a second modification to the technical document based on the updated recommendation for the technical document.

7. The computer-implemented method of claim 1, wherein the recommendation comprises the set of microguidelines, a weight for each of the set of microguidelines, data indicating that each of the set of microguidelines that was satisfied or not satisfied, identification of a gap or noncompliance in the technical document, and a remediation action for the gap or the noncompliance in the technical document.

8. A system comprising:
a memory having computer readable instructions; and
one or more processors for executing the computer readable instructions, the computer readable instructions controlling the one or more processors to perform operations comprising:
determining an assessment type for a technical document received from a user device;
analyzing the technical document using a set of microguidelines associated with the assessment type;
generating an alignment score using the set of microguidelines;
generating a recommendation for the technical document based on the alignment score and the set of microguidelines; and
initiating a modification to the technical document based on the recommendation for the technical document.

9. The system of claim 8, wherein the operations further comprise:
receiving a guideline document from the user device, wherein the guideline document is unstructured;
extracting a guideline from the guideline document;
determining the assessment type based on the guideline; and
in response to determining that the guideline corresponds to an existing microguideline of the set of microguidelines, mapping the guideline to the existing microguideline.

10. The system of claim 9, wherein the operations further comprise:
in response to determining that the guideline does not correspond to the set of microguidelines associated with the assessment type, generating a new microguideline corresponding to the guideline; and
associating the new microguideline with the assessment type.

11. The system of claim 8, wherein the operations further comprise:
in response to the recommendation, receiving a weight modification for a microguideline of the set of microguidelines from the user device;
generating a user exception rule; and
associating the user exception rule with a user profile associated with the user device and the assessment type.

12. The system of claim 11, wherein the operations further comprise:
re-analyzing the technical document using the set of microguidelines associated with the assessment type and the user exception rule associated with the user profile;
generating an adjusted alignment score using the set of microguidelines and the user exception rule; and
generating an updated recommendation for the technical document based on the adjusted alignment score, the user exception rule, and the set of microguidelines.

13. The system of claim 8, wherein the operations further comprise:
determining a second assessment type for the technical document;
analyzing the technical document using a second set of microguidelines associated with the second assessment type;
generating a second alignment score using the second set of microguidelines;
generating an updated recommendation for the technical document using the second alignment score and the second set of microguidelines; and
initiating a second modification to the technical document based on the updated recommendation for the technical document.

14. The system of claim 8, wherein the recommendation comprises the set of microguidelines, a weight for each of the set of microguidelines, data indicating that each of the set of microguidelines that was satisfied or not satisfied, identification of a gap or noncompliance in the technical document, and a remediation action for the gap or the noncompliance in the technical document.

15. A computer program product comprising a computer readable storage medium having program instructions embodied therewith, the program instructions executable by one or more processors to cause the one or more processors to perform operations comprising:
determining an assessment type for a technical document received from a user device;
analyzing the technical document using a set of microguidelines associated with the assessment type;
generating an alignment score using the set of microguidelines;
generating a recommendation for the technical document based on the alignment score and the set of microguidelines; and
initiating a modification to the technical document based on the recommendation for the technical document.

16. The computer program product of claim 15, wherein the operations further comprise:
receiving a guideline document from the user device, wherein the guideline document is unstructured;
extracting a guideline from the guideline document;
determining the assessment type based on the guideline; and
in response to determining that the guideline corresponds to an existing microguideline of the set of microguidelines, mapping the guideline to the existing microguideline.

17. The computer program product of claim 16, wherein the operations further comprise:
in response to determining that the guideline does not correspond to the set of microguidelines associated with the assessment type, generating a new microguideline corresponding to the guideline; and
associating the new microguideline with the assessment type.

18. The computer program product of claim 15, wherein the operations further comprise:
in response to the recommendation, receiving a weight modification for a microguideline of the set of microguidelines from the user device;
generating a user exception rule; and
associating the user exception rule with a user profile associated with the user device and the assessment type.

19. The computer program product of claim 18, wherein the operations further comprise:
re-analyzing the technical document using the set of microguidelines associated with the assessment type and the user exception rule associated with the user profile;
generating an adjusted alignment score using the set of microguidelines and the user exception rule; and
generating an updated recommendation for the technical document based on the adjusted alignment score, the user exception rule, and the set of microguidelines.

20. The computer program product of claim 15, wherein the operations further comprise:
determining a second assessment type for the technical document;
analyzing the technical document using a second set of microguidelines associated with the second assessment type;
generating a second alignment score using the second set of microguidelines;
generating an updated recommendation for the technical document using the second alignment score and the second set of microguidelines; and
initiating a second modification to the technical document based on the updated recommendation for the technical document.
